(19) United States
(12) Patent Application Publication
(10) Pub. No.: US 2005/0073929 A1
(43) Pub. Date: Apr. 7, 2005

(54) Disk reproducing device

(75) Inventor: Hideki Mutou, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/938,781

(22) Filed: Sep. 13, 2004

(30) Foreign Application Priority Data
Oct. 3, 2003 (JP) 2003-346038

(51) Int. Cl. G11B 5/09

(52) U.S. Cl. 369/53.35; 369/47.17

(57) ABSTRACT

A disk reproducing device in which an error rate comparison and parameter determination block newly determines a parameter to minimize the error rate and a parameter setting block newly resets the determined parameter to a read block in accordance with the determination of readjustment determination block, when the data of use environmental information from a pickup, environmental change detection block, and vibration detection block is data showing a predetermined change and an error rate from error rate measurement block becomes worse than a minimum error rate stored in error rate storage block by a predetermined amount or more.

### BACKGROUND OF THE INVENTION

1. Field of the Invention

The present invention relates to a disk reproducing device in which an error rate in the reading of information data recorded on a disk is set to be minimized.

2. Description of the Related Art

The level of an error rate in a reading of information data recorded on a disk is an important factor that has an effect on basic performance as a disk reproducing device.

One of conventional disk reproducing devices in which this error rate is made to be minimized is disclosed as described below (for example, see patent document 1).

This disk reproducing device is provided with: a reproducing unit including read block for reading data recorded on a disk that is input via a pickup, error correction block for making a correction to data read by the read block, and decoding block that decodes error corrected data and outputs respective data such as image, sound and the like; parameter setting block that sets a parameter for determining the characteristics of a reading operation to the read block; parameter storage block that previously stores various parameters and has the parameters read by the parameter setting block; error rate measurement block that measures an error rate from the data of the number of errors corrected by the error correction block and the number of errors which cannot be corrected; and error rate comparison and parameter determination block that retrieves and determines a parameter to minimize an error rate from data measured by this error rate measurement block.

In the conventional disk device which are made to have above described construction, the retrieval and determination of the parameter to minimize an error rate is performed in the following manner.

The parameter setting block sequentially reads various parameters which are previously stored in the parameter storage block and sequentially changes the setting of parameters to the read block. A command of this sequential change of various parameters is issued to the parameter setting block from the error rate comparison and parameter determination block. The parameter setting block reads a specified parameter from the parameter storage block according to this command.

The error rate measurement block measures an error rate for each parameter which is sequentially changed in this manner. The measured error rate for each parameter is sent to the error rate comparison and parameter determination block and is once stored.

Predetermined kinds of parameters are sequentially set and error rates for the respective parameters are measured and then the error rate comparison and parameter determination block compares the data of error rate for the stored respective parameters and retrieves and determines a parameter to minimize the error rate. The parameter setting block sets the determined parameter to the read block.

In this manner, the read block is set to a reading operation to minimize an error rate.

The above described parameter setting is usually performed only once at a time of shipping a disk reproducing device. [Patent document 1] Japanese Unexamined Patent Publication No. 7-78302

A conventional disk reproducing device is constructed in the manner described above and has a function of setting a parameter in such a way as to minimize an error rate when the read block reads data, but the setting of a parameter to minimize error rate is usually performed only once at the time of shipping the disk reproducing device.

Therefore, the set parameter is one fixed under limited environmental conditions. For this reason, there is presented a problem that there is no means for setting a parameter again in the cases of, for example, a partial defect on a disk to be actually reproduced and events which affect the reproducing of a disk such as ambient temperature, ambient humidity, magnetic field, vibration or the like and further in a case where the set parameter is not appropriate for a disk which is newly changed and loaded, and the like.

### SUMAMRY OF THE INVENTION

The present invention has been made to solve the above described problem. The object of the present invention is to provide a disk reproducing device that has detection blocks for detecting a partial defect on a disk, use environmental conditions including ambient temperature, ambient humidity, magnetic field, vibration or the like, and a disk change, and newly resets a parameter that is once set in response to the information of this detection block, thereby enabling reproduction performance to be always ensured.

A disk reproducing device in accordance with the present invention includes: an error rate comparison and parameter determination block that determines a parameter to minimize the measured error rate and makes the parameter setting block set the determined parameter to a read block; an error rate storage block that stores the minimum error rate; a use environmental information block that generates data of use environmental information; and a readjustment determination block making a determination that makes the error rate comparison and parameter determination block newly determine a parameter to minimize the error rate and makes the parameter setting block newly reset the determined parameter to the read block when data of use environmental information is data showing a predetermined change and the error rate becomes worse than a minimum error rate stored in the error rate storage block by a predetermined amount or more after the parameter to minimize the error rate is set.

Therefore, according to the present invention, when the measured error rate becomes worse than a minimum error rate by a predetermined amount or more, after the parameter which minimizes the error rate is once set, the parameter to minimize the error rate is newly reset. Hence, even if the partial defect on the disk or the use environment such as ambient temperature, ambient humidity, magnetic field, or vibration makes the initially set error rate worse in process of reproducing the disk, parameters can be newly reset to the read block. This produces an effect of capable of surely minimizing the error rate and always ensuring reproduction performance in process of reproducing the disk.

### BRIEF DESCRIPTION OF THE DRAWINGS

FIG. 1 is a block diagram to show the construction of a disk reproducing device in accordance with embodiment 1 of the present invention.

FIG. 2 is a flow chart for describing an operation of the disk reproducing device in accordance with embodiment 1 of the present invention.

### DETAILED DESCRIPTION OF THE PREFERRED EMBODIMENT

Hereinafter a preferred embodiment of the present invention will be described.

Embodiment 1

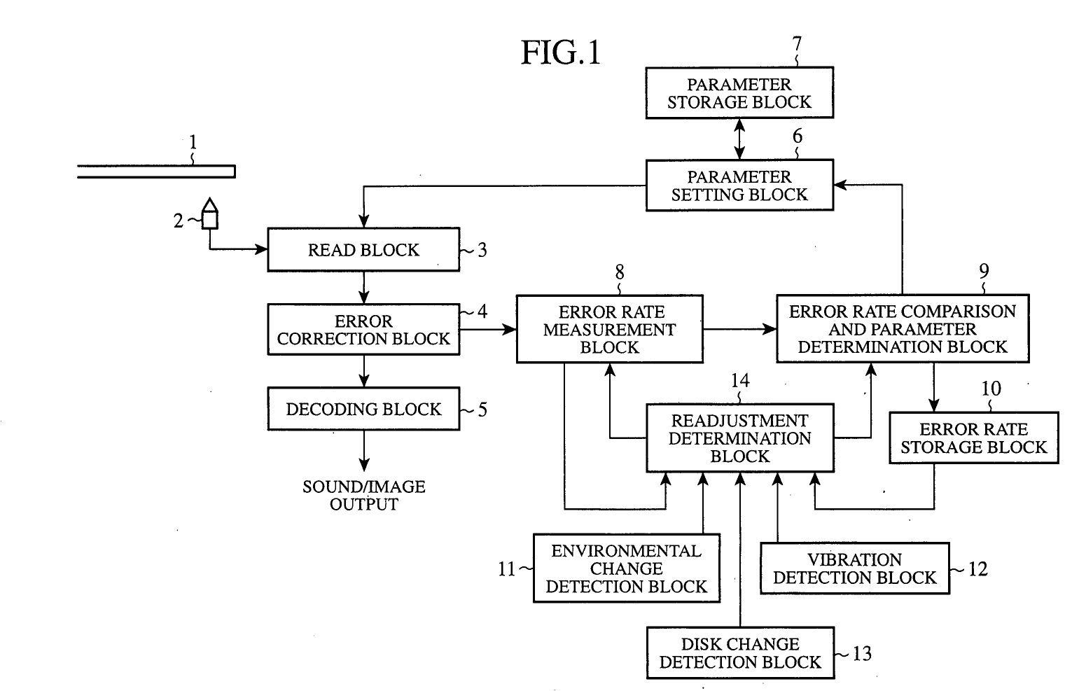

FIG. 1 is a block diagram to show the construction of a disk reproducing device in accordance with embodiment 1 of the present invention. In FIG. 1, this disk reproducing device is provided with: a reproducing unit including a pickup 2 for acquiring information data recorded on a disk 1, a read block 3 for reading data that is recorded on the disk 1 and input via the pickup 2, an error correction block 4 for making an error correction to data read by the read block 3, and a decoding block 5 that decodes data which is error corrected and outputs various data such as image, sound and the like; a parameter setting block 6 that sets a parameter for determining the characteristics of reading operation to the read block 3; a parameter storage block 7 that previously stores a plurality of kinds of parameters and has the parameters read by the parameter setting block 6; and an error rate measurement block 8 that measures an error rate from data such as the number of errors corrected and the number of errors which cannot be corrected by the error correction block 4.

Further, the disk reproducing device is provided with: an error rate comparison and parameter determination block 9 that retrieves and determines a parameter to minimize an error rate from data measured by the error rate measurement block; an error rate storage block 10 that stores a minimum error rate corresponding to a parameter determined by the error rate comparison and parameter determination block 9; an environmental change detection block 11 that detects environmental changes such as temperature, humidity, and magnetic field; a vibration detection block 12 for detecting vibrations; and a disk change detection block 13 for detecting the change of a disk.

Still further, the disk reproducing device is provided with a readjustment determination block 14 that makes the error rate comparison and parameter determination block 9 newly determine a parameter to minimize an error rate on the basis of data from the environmental change detection block 11, the vibration detection block 12, the disk change detection block 13 or the like, and makes a determination of making the parameter setting block 6 reset the determined parameter to the read block 3 when an error rate from the error rate setting block 8 becomes worse than a minimum error rate stored in the error rate storage block 10 by a predetermined amount or more after a parameter to minimize an error rate is set.

Moreover, to the readjustment determination block 14 are input not only information data from the environmental change detection block 11, the vibration detection block 12, and the disk change detection block 13 but also information data for monitoring the defect on a disk from the pickup 2. In these various kinds of information, the information data from the environmental change detection block 11, and the vibration detection block 12 are collectively called “use environmental information” and sources for generating these information are collectively called “use environmental information block”.

At this point, it is recommended that the environmental change detection block 11 be constructed of a temperature sensor for detecting ambient temperature, a humidity sensor for detecting ambient humidity, a magnetic sensor for detecting magnetic field, and the like. It is also recommended that the vibration detection block 12 be constructed of a G sensor for detecting the intensity of vibration and that the disk change detection block 13 be constructed of an optical sensor which detects a disk change.

In this regard, it is also recommended to employ another method for acquiring information of defects on the disk in which the readjustment determination block 14 always monitors an error rate measured by the error rate measurement block 8 and determines an occurrence of defect on a disk when this error rate becomes larger than a predetermined value.

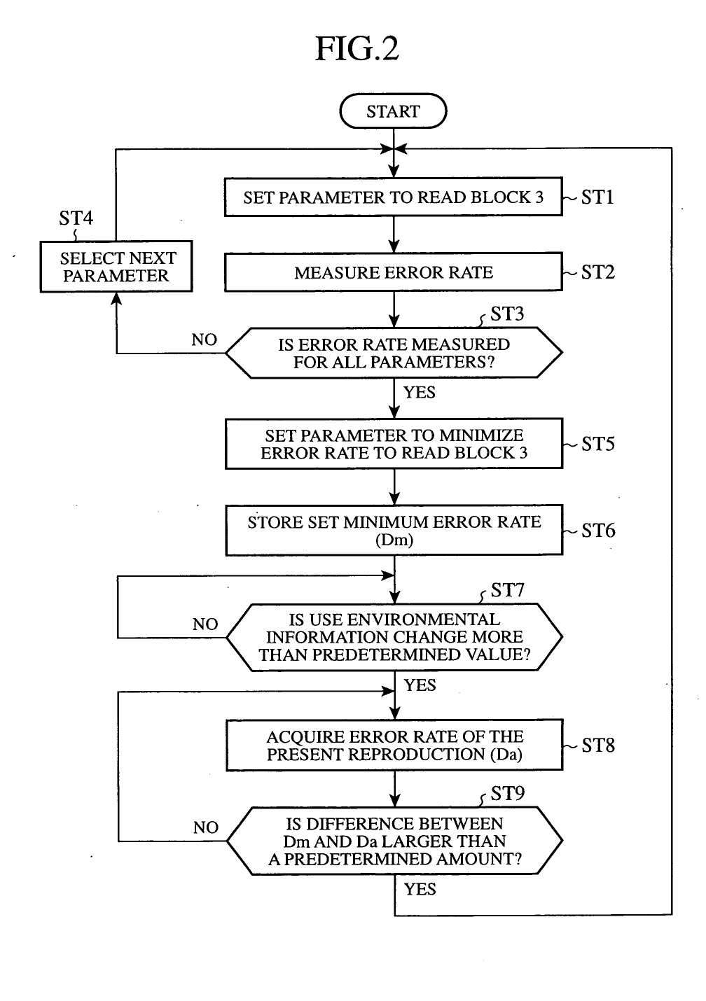

Next, an operation of the disk reproducing device in FIG. 1 will be described with reference to FIG. 2. Here, FIG. 2 is a flow chart for describing the operation.

In FIG. 2, at step ST1, a parameter for determining the characteristics of a reading operation is set to the read block 3 by the parameter setting block 6 in an early stage of the start of operation of this disk reproducing device (for example, at the time of shipment or the like). The read block 3 reads the data that is recorded on the disk 1 and inputs via the pickup 2 under this set parameter.

The data read by the read block 3 has errors corrected by the error correction block 4. The error corrected data is input to the decoding block 5 and decoded by it and the data such as image, sound or the like is output.

At step ST2, the information of error correction by the error correction block 4, that is, the data of the number of errors corrected by the error correction block 4 and the number of errors which cannot be corrected are sent to the error rate measurement block 8 and the error rate measurement block 8 measures an error rate from these data. The measured error rate is stored in the error rate comparison and parameter determination block 9.

At step ST3, the error rate comparison and parameter determination block 9 determines whether or not the error rate is measured for all predetermined parameters and when the error rate is not yet measured for all the parameters (step ST3—NO), the routine proceeds to step ST4.

At step ST4, the error rate comparison and parameter determination block 9 instructs the parameter setting block 6 to select and set the next parameter to the read block 3.

According to the above instruction, the parameter setting block 6 reads a predetermined parameter from the parameter storage block 7 and sets the read parameter to the read block 3 (step ST1). Thereafter, the routine proceeds to the above step ST2 and step ST3 where the above described determination is made also.

The above described steps ST1 to ST4 are repeated to sequentially change all parameters of predetermined kinds and the error rate is measured for each changed parameter.

When the measurement of error rate is completed for all parameters (step ST3—YES), the routine proceeds to step ST5.

At step ST5, the error rate comparison and parameter determination block 9 compares the data of error rate for all stored parameters to determine a parameter to minimize the error rate and instructs the parameter setting block 6 to set the determined parameter to the read block 3. According to this instruction, the parameter setting block 6 reads the determined parameter from the parameter storage block 7 and sets the read parameter to the read block 3.

At step ST6, the error rate storage block 10 stores a minimum error rate corresponding to the parameter determined and set at the step ST5. It is assumed that the stored data of the minimum error rate is “Dm”.

At step ST7, the readjustment determination block 14 monitors whether or not the use environmental information such as temperature, humidity, magnetic field, vibration or pickup output signal from the environmental change detection block 11, the vibration detection block 12, or the pickup 2 changes more than a predetermined amount or whether or not the disk change detection block 13 detects a disk change.

When the use environmental information changes more than the predetermined amount or when the disk change is detected (step ST7—YES) at the above monitoring, the routine proceeds to step ST8.

Whether or not the use environmental information changes more than the predetermined amount is a determination criterion for whether or not the routine proceeds to step ST8, and this determination criterion is previously set to the readjustment determination block 14 for each environmental element of temperature, humidity, magnetic field, vibration, and pickup output signal or in combination of these environmental elements.

In this regard, in a case where the above described readjustment determination block 14 always monitors the error rate measured by the error rate measurement block 8 in place of the output signal of the pickup 2 as a method for acquiring the information of defects on the disk, it is also recommended that this error rate is previously set as a determination criterion to the readjustment determination block 14 and that when the use environmental information becomes larger than this determination criterion, the readjustment determination block 14 determines that there is a defect on the disk and makes the routine proceed to step ST8.

At step ST8, the readjustment determination block 14 acquires the error rate of the present reproduction from the error rate measurement block 8. It is assumed that the data of acquired error rate is “Da”.

At step ST9, the readjustment determination block 14 reads the minimum error rate Dm stored in the error rate storage block 10 and compares this Dm with the error rate Da acquired from the error rate measurement block 8.

In this comparison, when Da>Dm and a difference between Da and Dm becomes larger than a predetermined amount (step ST9—YES), the readjustment determination block 14 makes a determination of readjusting a parameter setting to the read block 3 and returns the routine to step ST1.

The “predetermined amount” for the difference between Da and Dm is a determination criterion for determining whether or not readjustment is required and is previously set to the readjustment determination block 14 as is the case with the use environmental information at step ST7.

In this case, this “predetermined amount” may be set at different values for the respective environmental elements of the use environmental information or may be set at a constant value irrespective of the respective environmental elements.

By this arrangement, a partial defect on the disk and use environment such as temperature, humidity, magnetic field, or vibration, or a parameter appropriate for a new disk after exchange is newly reset to the read block 3 to minimize the error rate.

As for a specific example of the above described parameter, for example, the read block 3 has a PLL (phase lock loop) circuit provided therein, so the parameter to be set in the manner described above may be one for setting the operating state of this PLL circuit, for example, a cutoff frequency of a filter circuit constructing the PLL circuit.

Moreover, as for another example of parameter, the read block 3 has also an HPF (high pass filter) provided therein, so the parameter may be the cutoff frequency and boosted amount of this HPF.

A plurality of kinds of parameters as described above are previously prepared in the parameter storage block 7.

While it has been described above that the readjustment (setting) of the parameters is performed in the course of reproducing the disk, the readjustment (setting) of the parameters may be performed at a time of restarting (before the starting of reproducing the disk), for example, at the time of turning on the power again or return after reset.

In this case, it is recommended that the readjustment determination block 14 performs processing after the step ST8 by utilizing a signal of turning on the power again or a reset signal by use of the read data by the read block 3 at the time of restarting.

As described above, according to this embodiment 1, the disk reproducing device is constructed in such a way that after the parameters to minimize the error rate are set at the initial stage of the start of operation of this disk reproducing device, when the data from the pickup 2 and the use environmental information block such as the environmental change detection block 11 and vibration detection block 12 which show a predetermined change and the error rate from the error rate measurement block 8 becomes worse than the minimum error rate stored in the error rate storage block 10 by the predetermined amount or more, in accordance with the determination of the readjustment determination block 14, the error rate comparison and parameter determination block 9 newly determines a parameter to minimize the error rate and that the parameter setting block 6 newly resets the determined parameter to the read block 3. Hence, even if the initially set error rate is made worse by the partial defect on the disk or the use environment such as environmental temperature, environmental humidity, magnetic field, or vibration in the course of reproducing the disk, parameters can be newly reset to the read block 3. This can surely minimize the error rate and hence can always ensure reproduction performance in the course of reproducing the disk.

Further, since the detection of vibration by the vibration detection block 12 is a requirement of resetting a parameter, the present invention becomes particularly effective in a disk reproducing device which is mounted on a mobile body such as an automobile.

Still further, since whether or not a parameter is required to be newly reset is determined by both of the use environment and the degree of deterioration of error rate, the unnecessary reset of a parameter can be avoided to reduce the number of resets of the parameter.

Still further, the disk reproducing device according to this embodiment 1 is constructed in such a way that the disk change detection block 13 for detecting the change of disk 1 is provided and that when the detection data of a disk change is input from the disk change detection block 13, the readjustment determination block 14 makes a determination of resetting a parameter to minimize the error rate. Hence, also when a disk to be reproduced is changed, a parameter can be reset to the read block 3. This can prevent the error rate from being made worse by variations in the disk and the like and hence enables reproduction performance to be always ensured for each disk.

1. A disk reproducing device comprising:
a read block for reading data recorded on a disk;
a parameter storage block that stores a plurality of kinds of parameters for determining reading operation characteristics of the read block;
a parameter setting block that reads a required parameter from the parameter storage block and sets the required parameter to the read block;
an error correction block that makes a correction to data read by the read block and then outputs decoded data via decoding block;
an error rate measurement block that measures an error rate on the basis of result of error correction by the error correction block;
an error rate comparison and parameter determination block that determines a parameter to minimize the measured error rate and makes the parameter setting block set the determined parameter to the read block;
an error rate storage block that acquires a minimum error rate from the error rate comparison and parameter determination block and stores the minimum error rate;
a use environmental information block that generates data of use environmental information; and
a readjustment determination block making a determination that makes the error rate comparison and parameter determination block newly determine a parameter to minimize the error rate and makes the parameter setting block newly reset the determined parameter to the read block when data of use environmental information from the use environmental information block is data a predetermined change and the error rate from the error rate measurement block becomes worse than a minimum error rate stored in the error rate storage block by a predetermined amount or more after the parameter to minimize the error rate is set.

2. The disk reproducing device as claimed in claim 1, wherein the data of use environmental information includes any one or a combination of a plurality of data showing a defect on the disk, ambient temperature, ambient humidity, magnetic field, or vibration.

3. The disk reproducing device as claimed in claim 1, further comprising a disk change detection block for detecting a change of the disk, wherein when data of detecting the change of the disk is input from the disk change detection block, the readjustment determination block makes a determination of resetting a parameter to minimize the error rate.
